(19) United States
(12) Patent Application Publication
(10) Pub. No.: US 2010/0102254 A1
(43) Pub. Date: Apr. 29, 2010

(54) ELECTRON BEAM APPARATUS

(75) Inventor: Masaki Kobayashi, Tsurugashima-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Tokyo (JP)

(21) Appl. No.: 12/532,366

(22) PCT Filed: Mar. 22, 2007
(86) PCT No.: PCT/JP2007/055897

§ 371 Date: Oct. 21, 2009

(51) Int. Cl. G21K 5/00

(52) U.S. Cl. 250/492.3

(57) ABSTRACT

A writing apparatus includes a beam current detector which detects abeam current of the electron beam during execution of the writing when the substrate is not irradiated; a fluctuation value calculator which calculates a fluctuation value of the electron beam based on the beam current; and a corrector which corrects the electron beam fluctuation during the writing based on the fluctuation value.

### TECHNICAL FIELD

The present invention relates to an electron beam apparatus, and particularly relates to an electron beam writing apparatus for manufacturing a master disc or the like for recording media by irradiating with an electron beam.

### BACKGROUND ART

Electron beam writing apparatus for carrying out lithography using an electron beam are widely used in master disc manufacturing devices for optical discs such as Digital Versatile Discs (DVDs), Blu-ray discs, and so on, and large capacity discs such as hard discs and the like for magnetic recording. Further, they are also used in the manufacture of recorded media referred to as discrete track media and patterned media.

In electron beam writing apparatus, when manufacturing the master disc for the above-described discs, for example, a resist layer is formed on the recording surface of a substrate that is to be a master disc, the substrate is rotated, and by controlling the beam spot in the radial direction or the tangential direction as appropriate relative to the substrate writing surface that is moving in translation, spiral shaped or concentric circular shaped tracks are drawn on the substrate writing surface, and a latent image is formed on the resist.

In the electron beam writing apparatus, the electron beam optical system or the electron column that houses the optical system is vibrated by the vibrations of the stage for translational movement of the substrate or the rotational drive system, or by other external disturbances, and so on. Also, as a result of these vibrations, the position of irradiation of the electron beam on the substrate writing surface also fluctuates, so it is necessary to correct the fluctuations of the position of the electron beam.

A method for measuring the fluctuation of the position of the beam for carrying out the correction is, for example, disclosed in the following Patent Document 1. In the patent document, the fluctuation of the beam position is measured from the variation of the current using a beam current detector (Faraday cup) directly below the aperture on the optical axis of the ion beam optical system during measurement (the fixed method). However, beam position fluctuation data is collected before carrying out the writing, so the beam position fluctuation when carrying out the actual writing can be different from the beam position fluctuation when it was measured. Also, the correction signal is stored in memory, so the correction signal is limited to specific frequency components.

Further, when carrying out writing (recording) on the substrate (master disc), the correction is carried out by outputting the waveform stored in the memory while synchronizing with the specific frequencies to deflect the beam in the opposite direction to the fluctuation. Therefore, the correction is made by feed forward control, so the correction effect is small. Therefore in the conventional technology there is the problem that it is not possible to carry out correction of the fluctuations in the beam position to sufficient accuracy.

Patent Document 1: Japanese Patent Application Laid-open No. H08-212950 (page 3, FIG. 2)

### DISCLOSURE OF THE INVENTION

With the foregoing in view, one example of the objects of the present invention is to provide a beam writing apparatus capable of carrying out writing while correcting the fluctuations in the beam to a high accuracy.

An apparatus according to the present invention is a writing apparatus that carries out writing by forming a latent image on a resist layer by switching between irradiating and not irradiating an electron beam on a substrate formed with a resist layer due to deflection of the electron beam in accordance with a writing signal, which includes a beam current detector which detects a beam current of the electron beam during execution of the writing when the substrate is not irradiated; a fluctuation value calculator which calculates a fluctuation value of the electron beam based on the beam current; and a corrector which corrects the electron beam fluctuation during the writing based on the fluctuation value.

### BRIEF DESCRIPTION OF THE DRAWINGS

FIG. 1 is a block diagram schematically showing the configuration of the electron beam writing apparatus according to the first embodiment of the present invention;

FIG. 2 is a block diagram schematically showing the detailed configuration of the beam position fluctuation correction unit;

FIG. 3 is a diagram schematically showing the feedback control in the beam fluctuation correction control;

FIG. 4 is a block diagram schematically showing the beam fluctuation correction of the electron beam writing apparatus according to the second embodiment of the present invention;

FIG. 5 a diagram schematically showing the sampling and holding operations of the beam position fluctuation value when the beam is off (not irradiating); and

FIG. 6 is a diagram schematically showing the superimposition of the beam fluctuation measurement pulse (MP) on the beam modulation signal, and the sampling and holding operations when the beam is on.

### EXPLANATION OF THE REFERENCE NUMERALS

10 Electron beam writing apparatus
15 Substrate
23 Beam adjustment electrode
24 Beam modulation electrode
26 Aperture
27 Beam current detector
30 Controller
31 Beam adjustment circuit
32 Beam modulation circuit
33 Beam fluctuation measurement circuit
41 Sample/hold circuit
42 Correction signal generator
43 Beam correction circuit
45 Electron beam controller

### BEST MODE FOR CARRYING OUT THE INVENTION

The following is a detailed descrption of the embodiments of the present invention with reference to the drawings. In the following embodiments, equivalent constituent elements are given the same reference numerals.

### First Embodiment

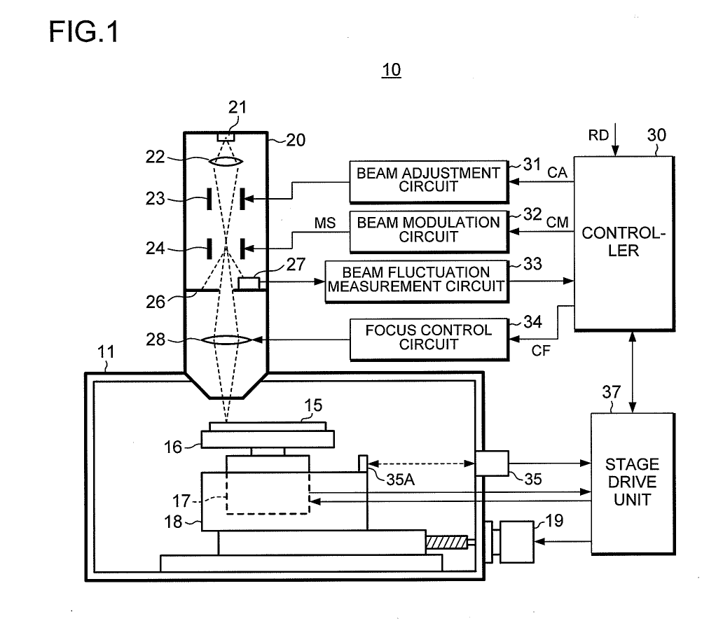

FIG. 1 is a block diagram schematically showing the configuration of an electron beam writing apparatus 10 according to the first embodiment of the present invention. The electron beam writing apparatus 10 is a disc mastering apparatus for producing the master disc for the manufacture of optical discs or hard discs.

### [Configuration and Operation of the Electron Beam Writing Apparatus]

The electron beam writing apparatus 10 is provided with a vacuum chamber 11, a drive device for placing, rotating, and translating a substrate 15 disposed in the vacuum chamber 11, and an electron beam column 20 fitted to the vacuum chamber 11, and various circuits and control systems for drive control of the substrate and control of the electron beam, and so on.

In more detail, a resist is applied to the surface of the substrate 15 for the master disc, and the substrate 15 is placed on a turntable 16. The turntable 16 drives the substrate 15 in rotation about the axis normal to the disc substrate main surface using a spindle motor 17, which is a rotational drive device for rotating the substrate 15. Also, the spindle motor 17 is provided on a moving stage (hereafter also referred to as the X stage) 18. The X stage 18 is connected to a travel motor 19, which is a translation drive device, which is capable of moving the spindle motor 17 and the turntable 16 in a predetermined direction (the X-direction) in a plane parallel to the main surface of the substrate 15. Therefore, the X stage 18, the spindle motor 17, and the turntable 16 constitute an Xθ stage. The X stage 18 may also be capable of moving in the direction normal to the x-direction (the y-direction) in a plane parallel to the main surface of the substrate 15.

The spindle motor 17 and the X stage 18 are driven by a stage drive unit 37, and the stage drive amount, such as the X stage 18 travel amount and the turntable 16 rotation angle (in other words, the substrate 15 rotation angle), and so on, is controlled by a controller 30.

The turntable 16 is made from a dielectric material such as, for example, a ceramic, and has a chucking mechanism such as an electrostatic chucking mechanism that holds the substrate 15 (not shown on the drawings). The substrate 15 placed on the turntable 16 is securely fixed to the turntable 16 using the chucking mechanism.

A reflection mirror 35A, which is a part of a laser interferometer 35, is disposed on the X stage 18.

The vacuum chamber 11 is installed on an anti-vibration platform (not shown on the drawings) such as an air damper or the like, to suppress the transmission of vibrations from outside. Also, the vacuum chamber 11 is connected to a vacuum pump (not shown on the drawings), so that the interior of the vacuum chamber 11 is set to a vacuum environment with a predetermined pressure by evacuating air from within the chamber using the vacuum pump.

Within the electron beam column 20, an electron beam gun (emitter) 21, a focusing lens 22, beam adjustment electrodes 23, beam modulation electrodes 24, an aperture 26, and an object lens 28 are disposed in this order.

The electron beam gun 21 emits an electron beam (EB) accelerated to, for example, tens of keV, by applying a high voltage supplied from an acceleration high voltage, source (not shown on the drawings) to a cathode (not shown on the drawings). The focusing lens 22 converges the emitted electron beam.

The beam adjustment electrodes 23 can adjust and control the electron beam at high speed based on adjustment signals from a beam adjustment circuit 31. As described later, using this control various adjustments to the beam fluctuations are carried out, such as adjustment of the electron beam irradiation position on the substrate 15, beam diameter adjustments, and so on.

The beam modulation electrodes 24 and the aperture 26 constitute an electron beam modulator. The beam modulation electrodes 24 turn the electron beam irradiation of the substrate 15 on and off (ON/OFF) using an electron beam blanking control based on modulation signals from a beam modulation circuit 32.

In other words, the electron beam is prevented from passing through the aperture 26 by deflecting the electron beam that passes the beam modulation electrodes 24 to which a voltage is applied using, for example, electrostatic deflection. In other words, the aperture 26 prevents the electron beam from irradiating the substrate 15 (when the beam is off). Also, when a voltage is not applied to the beam modulation electrodes 24, the electron beam irradiates the substrate 15 (when the beam is on).

A beam current detector 27 is provided on the aperture 26 for measuring the beam current when the beam is off. More specifically, the beam current detector 27 is provided in the position irradiated by the electron beam when the beam is off. The electron beam current measured by the beam current detector 27 is supplied to a beam fluctuation measurement circuit 33. The beam fluctuation measurement circuit 33 calculates the electron beam positional fluctuation value based on the measured current value.

The focus lens 28 is driven based on drive signals from a focus control circuit 34, and controls the focus of the electron beam.

The laser interferometer 35 measures the displacement of the X stage 18 using laser light emitted from a light source in the laser interferometer 35. Specifically, the displacement of the X stage 18 is measured based on laser light reflected from the reflection mirror 35A provided on the X stage 18, and the measurement data, in other words the X stage 18 travel (X direction) position data is sent to the stage drive unit 37.

Further, the rotation signal of the spindle motor 17 is supplied to the stage drive unit 37. In more detail, the rotation signal includes an origin point signal that represents a standard rotational position of the substrate 15, and a pulse signal (rotary encoder signal) for each specific rotation angle from the standard rotational position. The stage drive unit 37 obtains the rotation angle, the rotation speed, and so on, of the turntable 16 (that is, the substrate 15) from the rotation signal.

The stage drive unit 37 generates positional data that represents the position of the electron beam spot on the substrate, based on the travel positional data from the X stage 18 and the rotation signal from the spindle motor 17, and supplies the data to the controller 30. Also, the stage drive unit 37 drives the spindle motor 17 and the travel motor 19 based on control signals from the controller 30, so that they are driven to rotate and travel.

Track pattern data or data for writing (exposure) RD (writing data) to be used for optical discs, magnetic discs, or discrete track media or patterned media and the like are supplied to the controller 30.

Then, as described above, the beam modulation circuit 32 controls the beam modulation electrodes 24 based on the writing data RD, and the electron beam is modulated ON and OFF (switches between irradiation and non-irradiation of the substrate 15) in accordance with the writing data RD.

The controller 30 sends to the beam adjustment circuit 31, the beam modulation circuit 32, the beam fluctuation measurement circuit 33, and the focus control circuit 34 a beam adjustment signal CA, a beam modulation signal CM, and a beam fluctuation measurement signal CF, respectively, and controls the data writing (exposure or recording) based on the recording data RD. In other words, the resist on the substrate 15 is irradiated by the electron beam (EB) based on the recording data RD, and writing is carried out by forming a latent image only in the locations exposed to the irradiation of the electron beam.

### [Configuration and Operation of the Beam Position Fluctuation Correction Unit]

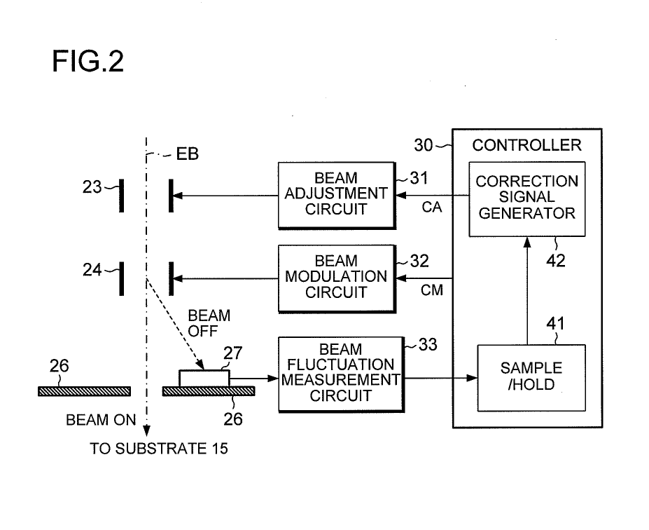

FIG. 2 is a block diagram schematically showing the detailed configuration of the beam position fluctuation correction unit. When electron beam writing is carried out, the electron beam current is measured, and the beam fluctuation correction is carried out based on the measured current.

More specifically, when the writing is carried out based on the writing data RD, in other words when modulating the electron beam, the electron beam (EB) is measured when the substrate 15 is not being irradiated. In other words, the substrate 15 is irradiated by the electron beam EB corresponding to the binary value “1” in the writing data RD (beam on), the electron beam EB is deflected (blanking) corresponding to the binary value “0” and does not irradiate (beam off), and when the beam is off (not irradiating) the electron beam EB is incident on the beam current detector 27 provided on the aperture 26. Also, the substrate 15 may be irradiated by the electron beam EB corresponding to the binary value “0” in the writing data RD (beam on), the electron beam EB may be blanked and not irradiated corresponding to the binary value “1” (beam off), and when the beam is off (not irradiating) the electron beam EB is incident on the beam current detector 27 provided on the aperture 26.

In other words, when carrying out electron beam writing, when the beam is turned off by beam modulation, the electron beam EB is sampled, and the beam current is measured. Therefore, during beam writing (drawing or recording), it is possible to detect and measure the beam fluctuation in real time.

The beam current detector 27 includes, for example, a Faraday cup (FC), and the amount of variation in the beam current is measured by the Faraday cup FC. The Faraday cup FC is disposed in a position where, for example, when the beam is turned off (not irradiating) a part of the electron beam EB (for example, 50%) is incident. Or, the Faraday cup FC is constituted so that when the beam is turned off (not irradiating) a part of the electron beam EB is shielded and incident on the Faraday cup FC.

When beam fluctuation is produced in the beam irradiation position (that is, the position of irradiation on the substrate 15) or the like, due to fluctuations or the like in the beam emission direction of the electron beam EB, when the beam is on, the beam current also varies when the beam is off (not irradiating). Therefore, the amount of variation in the beam current is measured by the beam current detector 27 (i.e., Faraday cup FC).

The beam current detector 27 may also be constituted as a divided current detector having a plurality of current detectors that receive the electron beam EB when the beam is turned off (not irradiating). For example, the beam current detector 27 may be constituted as a four-division current detector having four current detection units, so that it is possible to measure the fluctuation of the electron beam EB, in other words the fluctuation of the beam position (beam orientation), the beam strength, the beam diameter, and so on, based on the variation in each of the measured current values of each of the four current detection units.

The beam current measured by the beam current detector 27 is supplied to the beam fluctuation measurement circuit 33. The beam fluctuation measurement circuit 33 calculates the fluctuation value in the electron beam based on the measured current value. In the following, an example is described for the case where the beam position fluctuation value is calculated by the beam fluctuation measurement circuit 33, and the irradiation position of the electron beam EB on the substrate 15 is corrected when the beam is on.

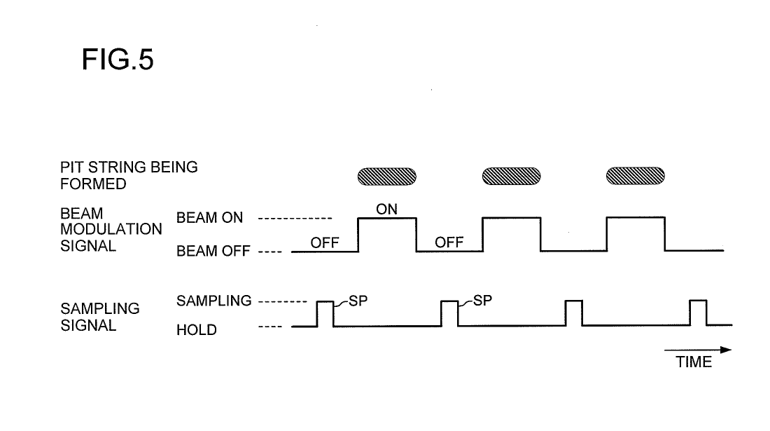

The beam position fluctuation value calculated by the beam fluctuation measurement circuit 33 is supplied to a sample/hold circuit 41, and the sampling position fluctuation value is held. More specifically, as shown in FIG. 5, when the beam is turned off (not irradiating), the beam position fluctuation value is sampled in accordance with a sampling signal (sampling pulse: SP) when the beam is turned off (not irradiating), which is the time that a pit is not being formed, and the positional fluctuation value is held.

Then, the positional fluctuation value is supplied to a correction signal generator 42, and based on the positional fluctuation value (the value held), a control signal (correction signal) is generated for correcting the positional fluctuation. The correction signal is supplied to the beam adjustment circuit 31, and the beam adjustment circuit 31 controls the beam adjustment electrodes 23 based on the correction signal. In other words, the beam position is adjusted by deflection control of the electron beam EB emitted from the electron gun 21. In other words, the correction signal generator 42 and the beam adjustment circuit 31 function as a corrector for correcting the positional fluctuation when the electron beam EB is irradiating the substrate 15. In this way, it is possible to correct the irradiation position of the electron beam EB on the substrate 15.

As shown in FIG. 2, the sample/hold circuit 41 and the correction signal generator 42 are provided in, for example, the controller 30, and their operation is controlled by the controller 30.

Also, in the above it was described that sampling is carried out when the beam is turned off (not irradiating), that is, during the period that a pit is not being formed, but sampling may also be carried out during the period when the beam is turned on (irradiating). That is, the beam fluctuation measurement signal (pulse) may be superimposed on the beam modulation signal, and constituted so that sampling is carried out during the period when the beam is on (irradiating).

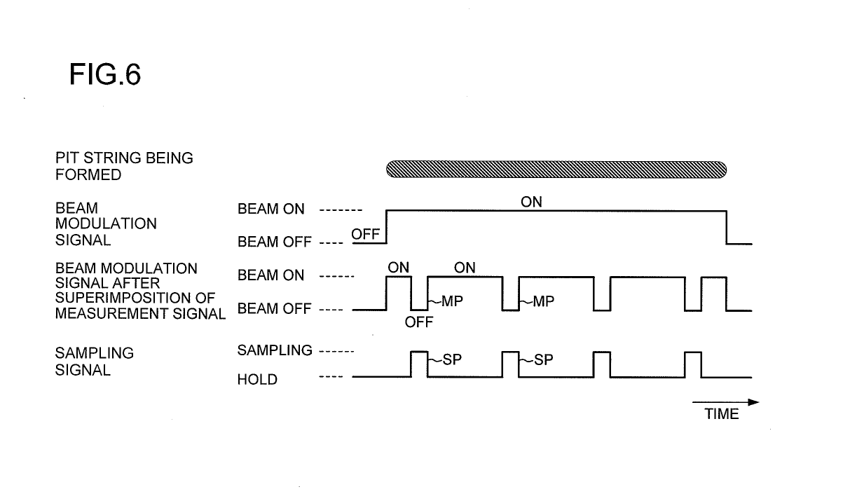

More specifically, as shown in FIG. 6, when the pit length is long, or when there is no beam off (not irradiating) time (for example, when forming a groove) and the like, during the beam-on period when the beam should be irradiating the substrate, the beam fluctuation measurement pulse (MP) is superimposed on (or applied to) the beam modulation signal. During the period when the beam fluctuation measurement pulse (MP) is superimposed the beam is turned off (not irradiating), so it is possible to constitute that sampling is executed in the measurement pulse (MP) superimposition time period.

For example, the controller 30 may be constituted to superimpose the beam fluctuation measurement signal on the beam modulation signal CM of the beam modulation circuit 32. In this case, the controller 30 functions as a fluctuation measurement beam switching unit that controls the beam modulation circuit 32 and switches the beam to not irradiate. Also, the beam current detector measures the beam current during the switching period (measurement pulse superimposition period). Then the beam fluctuation value is calculated based on the measured current value, and the irradiation position is corrected.

The measurement pulse superimposition time period can be a short that has no effect on the continuity of exposure (writing) of the resist. In other words, even when forming a long pit or a groove, it is possible to select a measurement pulse superimposition time period so that discontinuity is not produced in the pit or the groove, in accordance with the writing speed (linear speed) and the resist characteristics (sensitivity) and so on.

According to the configuration, even when the pit length is long or when there is no beam off (not irradiating) time period, it is possible to shorten the sampling time and carry out the beam fluctuation measurement, so it is possible to correct the beam fluctuation with high frequency. In other words, it is possible to correct the beam fluctuation with high accuracy.

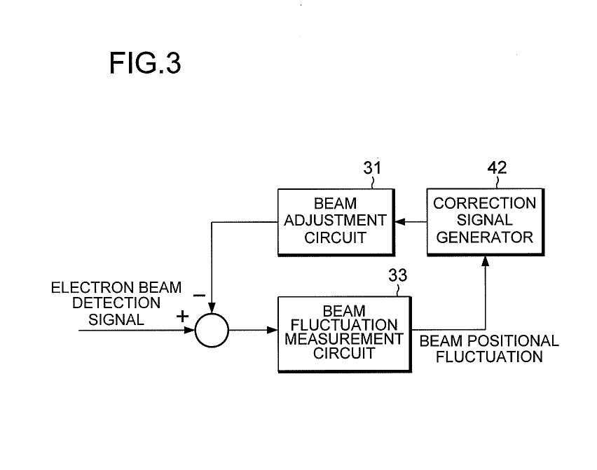

FIG. 3 schematically shows the beam fluctuation correction control as described above. In other words, according to the present embodiment, beam fluctuation correction is carried out based on the electron beam fluctuation value (for example, the beam position fluctuation value) from the beam fluctuation measurement circuit 33, and feedback control is realized in which the correction result is fed back. Therefore, the correction effect is significantly improved compared with the conventional feed forward control.

As described above, when electron beam writing is being executed based on the writing data RD, the non-irradiating electron beam EB that is deflected by beam modulation is sampled, and the beam current is measured. Then, the electron beam EB is corrected based on the positional fluctuation value calculated from the measured beam current. Therefore, the beam fluctuation can be measured in real time and the beam corrected during beam writing, and correction by feedback control is realized.

In the above, an example in which the fluctuation of the beam position was described, but as explained in connection with the beam current detector 27, it is possible to carry out correction by feedback control for beam fluctuations in the beam strength, the beam diameter, and so on, based on the measured current of the beam current detector 27.

### Second Embodiment

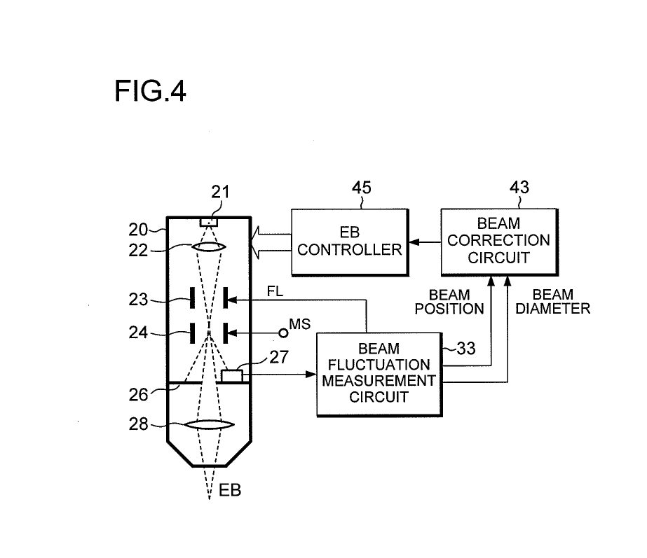

FIG. 4 is a block diagram schematically showing the configuration of the beam fluctuation correction of the electron beam writing apparatus 10 according to the second embodiment of the present invention. The measurement of the electron beam current when carrying out electron beam writing and carrying out the beam fluctuation correction based on the measured current is the same as the above embodiment.

The beam current measured by the beam current detector 27 is supplied to the beam fluctuation measurement circuit 33. The beam fluctuation measurement circuit 33 calculates the beam positional fluctuation value and the beam diameter fluctuation value as the fluctuation values the electron beam based on the measured current value.

For example, when the beam is turned off, a minute deflection voltage (FL) is superimposed on the beam adjustment electrodes 23, and it is possible to measure the beam diameter fluctuation and/or the beam positional fluctuation of the electron beam EB. For example, the Faraday cup FC is provided with a limited field of view (that is, beam incident area) so that a part of the electron beam EB is incident when the beam is turned off (not irradiating). Then, when the minute deflection voltage is applied to the beam adjustment electrodes 23 when the beam is turned off (not irradiating), it is possible to measure the beam diametral in the same way as the normal deflection method, by measuring the beam current variation and the transient characteristics at that time. Alternatively, as stated previously, the beam diameter, the deviation from a true circle of the beam spot (the ellipticity), and so on can be measured using the four-division current detector or the like.

The beam positional fluctuation value and the beam diametral fluctuation value calculated by the beam fluctuation measurement circuit 33 are supplied to a beam correction circuit 43. The beam correction circuit 43 generates control signals (beam correction signals) for correcting the beam positional fluctuation and the beam diametral fluctuation, and supplies them to an electron beam control unit (EB controller) 45. The EB controller 45 controls the electron beam optical system, including the generation of the electron beam EB, the electron beam optical axis, the beam shape, the deflection, the focus, and so on. Also, the minute deflection voltage FL can be constituted to be applied by the EB controller 45.

The EB controller 45 adjusts the electron beam EB emitted from the electron gun 21 based on the beam correction signal from the beam correction circuit 43. In this way, it is possible to correct the irradiation position and correct the beam diameter of the electron beam EB on the substrate 15.

Also, similar to the above embodiment, electron beam fluctuation correction is realized by feedback control. Therefore, the correction effect is significantly improved compared with conventional feed forward control.

As explained above, and similar to the above embodiment, while electron beam writing is being executed, the deflected non-irradiating electron beam EB is sampled when the beam is turned off, and the beam current is measured. Then, based on the measured beam fluctuation value, correction to the electron beam EB is executed. Therefore, the beam fluctuation is measured in real time while beam writing is being carried out and the beam is adjusted, so correction by feedback control is realized.

In the above embodiments, the example of an electron beam writing apparatus was described, but in general the present invention may also be applied to the control of the amount of fluctuation of the irradiation position and the like of a charged beam that is emitted onto a target such as a substrate or test specimen or the like.

1. A writing apparatus that carries out writing by forming a latent image pattern in accordance with writing data on a resist layer by switching between irradiating and not irradiating an electron beam on a substrate formed on the resist layer by deflecting the electron beam in accordance with a writing signal, comprising:
a beam current detector which detects a beam current of the electron beam when the substrate is not being irradiated during performing the writing;
a beam modulation portion which makes the electron beam incident on the beam current detector when the substrate is not being irradiated;
a fluctuation value calculator which calculates a fluctuation of an irradiation position of the electron beam in the beam current detector based on the beam current; and
a corrector which corrects an electron beam positional fluctuation on the substrate based on the fluctuation.

2. The writing apparatus according to claim 1, wherein the fluctuation is a fluctuation of the beam irradiation position on the substrate, and the corrector corrects a positional fluctuation of the electron beam irradiation to the substrate during the writing.

3. The writing apparatus according to claim 1, wherein the fluctuation is a fluctuation of the beam irradiation position and the beam diameter on the substrate, and the corrector corrects the positional fluctuation of irradiation and the beam diameter on the substrate during the writing.

4. The writing apparatus according to claim 1, comprising a minute deflection unit that minutely deflects the electron beam when the electron beam is not irradiating the substrate during the execution of writing, wherein
the fluctuation value calculator calculates the electron beam fluctuation based on the minutely deflected electron beam.

5. The writing apparatus according to claim 1, comprising a beam switching unit for fluctuation measurement which switches the electron beam to a non-irradiation mode during a period in which the electron beam is to be irradiating the substrate, wherein
the beam current detector measures the beam current of the electron beam during the period in which the electron beam is switched.

6. The writing apparatus according to claim 1, further comprising:
a controller which switches between irradiating and not irradiating the electron beam in accordance with the writing data; and
a signal generator for generating a sampling signal which makes the electron beam incident on the beam current detector when the substrate is not being irradiated.

7. A writing apparatus that carries out writing by forming a latent image pattern in accordance with writing data on a resist layer by switching between irradiating and not irradiating an electron beam on a substrate formed on the resist layer by deflecting the electron beam in accordance with a writing signal, comprising:
a beam current detector which detects a beam current of the electron beam when the substrate is not being irradiated during performing the writing;
a signal generator for generating a sampling signal which makes the electron beam incident on the beam current detector at an arbitrary timing during when the substrate is to be irradiated with the electron beam to form the latent image pattern;
a beam modulation portion which makes the electron beam incident on the beam current detector in accordance with the sampling signal;
a fluctuation value calculator which calculates a fluctuation of an irradiation position of the electron beam in the beam current detector based on the beam current; and
a corrector which corrects an electron beam positional fluctuation on the substrate based on the fluctuation.
